(19) United States
(12) Patent Application Publication
(10) Pub. No.: US 2016/0279010 A1
(43) Pub. Date: Sep. 29, 2016

(54) Passive Knee Joint Flexion Device

(71) Applicant: David C. Lutz, Boerne, TX (US)

(72) Inventor: David C. Lutz, Boerne, TX (US)

(21) Appl. No.: 14/670,644

(22) Filed: Mar. 27, 2015

(51) Int. Cl. A61H 1/02

(52) U.S. Cl. CPC A61H 1/024

(57) ABSTRACT

Disclosed is a passive gravity assist flexion device, principally for knee joint flexibility; having such arrangement to provide appropriate content stable elevated support of the posterior intersection, concerning the femur and tibia of an impaired knee joint; whereby promoting gravity assist passive flexion towards gradual comfortable knee joint muscle stretching. The disclosed device arrangement comprised of a padded single knee posterior horizontal support bar, capable of desired lateral rotational movement, while firmly affixed mid-span atop a vertical linear traveling height adjustment threaded rod. Whereby adjustment rod thread engagement means establishes and maintains desired knee posterior horizontal support bar height position. Furthermore, the disclosed device utilizes a center base foundation arrangement providing a resolute vertical stable support device.

### BACKGROUND OF THE INVENTION

Subsequent of knee injury and/or surgery, some form of resolve is imperative towards restoring normal joint flexion by gradual stretching of contracted associated muscle; frequently accomplished by having some form of elevated support placed directly beneath the knee joint, performing as a fulcrum, from which the leg's lower portion slowly descends, passively elongating allied muscle. Examples of such type fulcrums being: a paper towel roll; having another as a tightly rolled cotton towel, fashioning a cylinder; conceivably a sofa arm or even a bed and/or table's perimeter.

One practice is by having an individual supine positioned on a fairly flat surface, such as a table; bending the non-impaired leg at somewhat of a 45 degree angle, having their foot sole flatly placed, thereby fashioning an apex for which a second party can place the palm of a hand upon; thereby achieving an under bridge for which the impaired knee posterior may rest upon; functioning as an elevated fulcrum for which the leg's lower portion may slowly descend, gradually stretching knee joint muscle.

Towards this end, specific prior art is absent associated with knee joint gravity assist passive flexion. This being dedicated devise(s) that resolutely support the posterior of a knee joint at a fixed elevated posture. Conversely, one specific element missing from all the above briefly described fulcrums is their inability to contently adapt for minimal individual knee joint left to right natural pivotal movement, while the lower leg gradually descends. Devoid of this simple capability, traditional solutions can be fairly uncomfortable.

### SUMMARY OF THE INVENTION

Disclosed is a passive gravity assist flexion device, principally for knee joint flexibility; having such arrangement to provide appropriate content stable elevated support of the posterior intersection, concerning the femur and tibia of an impaired knee joint; whereby promoting gravity assist passive flexion towards gradual comfortable knee joint muscle stretching. The disclosed device arrangement comprised of a padded single knee posterior horizontal support bar, capable of desired lateral rotational movement, while firmly affixed mid-span atop a vertical linear traveling height adjustment threaded rod. Whereby adjustment rod thread engagement means establishes and maintains desired knee posterior horizontal support bar height position. Furthermore, the disclosed device utilizes a center base foundation arrangement providing a resolute vertical stable support device.

The above brief description sets forth rather broadly the more important features of the present invention in order that the detailed description thereof that follows may be better understood, and in order that the present contributions to the art may be better appreciated. There are, of course, additional features of the present invention that will be described hereinafter and which will form the subject matter of the claims appended hereto.

In this respect, before explaining the preferred embodiment of the present invention in detail, it is to be understood that the invention is not limited in its application to the details of the construction and to the arrangements of the components set forth in the following description or illustrated in the drawings. The present invention is capable of other embodiments and of being practiced and carried out in various ways. Also, it is to be understood, that the phraseology and terminology employed herein are for the purpose of description and should not be regarded as limiting.

As such, those skilled in the art will appreciate that the concept, upon which this disclosure is based, may readily be utilized as a basis for designing other structures, methods, and systems for carrying out several purposes of the present invention. It is important, therefore, that the claims be regarded as including such equivalent constructions insofar as they do not depart from the spirit and scope of the present invention.

It is therefore an objective of the present invention to provide a new and unique economically realized passive knee muscle stretching device, wherein the various elements of the invention can be examined towards purposeful knee joint flexibility.

An additional objective of the present invention is providing such an arrangement to appropriately and contentedly support the posterior intersection relationship of the femur and tibia of an impaired knee joint; whereby promoting gravity assist passive flexion specific towards gradual knee joint muscle stretching.

It is also an objective of the present invention to provide a device comprised of a somewhat supple rubber padded horizontal knee posterior support bar; whereas the soft rubber pad could be realized from such material as neoprene, polysulfide, silicone, urethane, but not limited to; whereas said horizontal knee posterior support bar being of predetermined length, having rounded ends; incorporating a vertical coaxial bored hole and counter-bore located mid span; whereby having a second smaller diameter horizontally aperture located 90 degrees opposed of said vertical bored hole; whereby said solid support bar, round in form; being realized from such material as ferrous or nonferrous metal, plastic, wood, carbon fiber, composite, fiberglass, but not limited to.

It is also an objective of the present invention to provide a device comprised of a height adjustment threaded rod; whereby said predetermined length threaded rod having one end diameter tolerance machined to a determined length; being realized from such material as ferrous or nonferrous metal, plastic, wood, carbon fiber, polycarbonate, composite, fiberglass, but not limited to.

It is also an objective of the present invention to provide a device comprised of an internally threaded bushing or similar such element; being of determined length and form; being machined or mold formed; realized from such material as ferrous or nonferrous metal, plastic, wood, carbon fiber, polycarbonate, thermo setting plastic(s), composite, fiberglass, but not limited to.

It is also an objective of the present invention to provide a device comprised of a single vertical support housing; whereas said housing being of tube form; being of predetermined length similar to that of said threaded rod; having blunt ends; realized from such material as ferrous or nonferrous metal, plastic, wood, carbon fiber, polycarbonate, composite, fiberglass, but not limited to.

It is also an objective of the present invention to provide a device comprised of a single center base or hub; being circular in form; whereby being machined, mold and/or cast formed; having a center located vertical bore, of determined depth and diameter, being considered downward traveling; moreover having numerous geometrically equally spaced horizontal bores, of determined depth and diameter located on hub circumference centerline, considering hub horizontal parallel planes; being realized from such material as ferrous or nonferrous metal, plastic, wood, carbon fiber, polycarbonate, thermo setting plastic(s), composite, fiberglass, but not limited to.

It is also an objective of the present invention to provide a device comprised of numerous individual, regarded as, base support horizontal extension tubes; being of determined diameter and length; whereby having blunt ends; realized from such material as ferrous or nonferrous metal, plastic, wood, carbon fiber, polycarbonate, composite, fiberglass, but not limited to.

It is also an objective of the present invention to provide a device comprised of base support horizontal extension tube having commercially available end caps; being mold formed rubber, but not limited to.

It is also an objective of the present invention whereby said single padded horizontal knee posterior support bar is mechanically affixed to said threaded rod, having threaded rod tolerance machined end inserted a predetermined depth in to cooperating support bar tolerance machined bore. Further, having considered permanent attachment accomplished by means of a single pin or roll pin, but not limited to, inserted through aligned cooperating apertures of both support bar and threaded rod machined end; whereby having support bar and threaded rod perpendicular.

It is also an objective of the present invention whereby having said internally threaded bushing be press-fit and/or chemical bond retained in to one of the said vertical support tube housing accommodating blunt end apertures; whereby realizing thread insertion of cooperating threaded rod free end in to said bushing; thereby affording determined pivotal ascending and descending vertical linear travel.

It is also an objective of the present invention whereby the mechanically affixed padded horizontal knee posterior support bar will horizontally rotate in concert with said adjustable threaded rod's clockwise or counter-clockwise rotation.

It is also an objective of the present invention whereby the opposed end of said vertical support tube housing be perpendicularly introduced in to the center base hub bore a predetermined depth; whereby accomplishing housing end entrapment by capitalizing on a tolerance interference fit association between a somewhat larger outside diameter housing end and that of a slightly reduced accommodating base hub receiving harbor bore; having this press fit amalgamation permanently affixed by means of mechanical, fusion or chemical bonding, but not limited to.

It is also an objective of the present invention wherein said center base hub, having numerous geometrically equally spaced nesting harbor bores located about said hub peripheral face; wherein being of determined depth and diameter; entertain the press-fit insertion of cooperating appendage blunt ends. Whereby having said press-fit amalgamation permanently affixed by means of mechanical, fusion or chemical bonding, but not limited to; thereby said appendages being considered horizontal relative of said base hub horizontal parallel planes, respectfully.

It is also an objective of the present invention wherein said appendages having accommodating rubber end caps pressed on exposed appendage blunt ends; thereby achieving a positive placement non-slip configuration.

It is another object of the present invention to provide a new knee joint gravity assist passive flexion device, which may be easily and efficiently manufactured and marketed.

It is a further objective of the present invention of knee joint gravity assist passive flexion assembly, which is of durable and reliable construction.

It is therefore an objective of the present invention to provide a new and unique economically realized passive manipulative knee muscle stretching device wherein the various elements of the apparatus can be examined.

An even further object of the present invention is to provide a new knee joint gravity assist passive flexion assembly, which is susceptible of a low cost of manufacture with regard to both material(s) and labor, and which accordingly is then susceptible of low price of sale to the consuming public, thereby making such a knee joint gravity assist passive flexion device readily available to the buying public.

These together with still other objects of the present invention, along with the various features of novelty, which characterize the present invention, are pointed out with particularity in the claims annexed to and forming a part of this disclosure. For a better understanding of the present invention, its operating advantages and the specific objects attained by its uses, reference should be made to the accompanying drawings and descriptive matter in which there are illustrated embodiments of the present invention.

### BRIEF DESCRIPTION OF THE DRAWINGS

The invention will be better understood and the above objects as well as objects other than those set forth above will become more apparent after a conscientious study of the following detail description thereof. Such description makes reference to the annexed drawings wherein:

FIG. 1 being a 3 dimensional illustration of the revealed present invention preferred embodiment.

FIG. 2 being an exploded 3 dimensional illustration of the revealed present invention preferred embodiment.

FIG. 3 being a forward facing partial sectional view of the knee posterior horizontal support bar attachment means illustrated in partial cross-section, and of the vertical height threaded rod adjustment engagement means illustration, again in partial cross-section, of the revealed present invention preferred embodiment.

FIG. 4 being a partial vertical downward view of the knee posterior horizontal support bar attachment means illustration, having hidden lines, of the revealed present invention preferred embodiment.

FIG. 5 being an artistic side view illustration of the revealed present invention preferred embodiment, in demonstration.

FIG. 6 being an artistic vertical downward view representative illustration of the revealed present invention horizontal knee posterior support bar preferred embodiment, in demonstration.

FIG. 7 being an artistic vertical downward view illustrative of the revealed present invention horizontal knee posterior support bar preferred embodiment, demonstrating gyratory capability.

FIG. 8 being a photograph of the revealed present invention preferred embodiment exhibited with and without foam rubber padding.

### DESCRIPTION OF THE PREFERRED EMBODIMENT

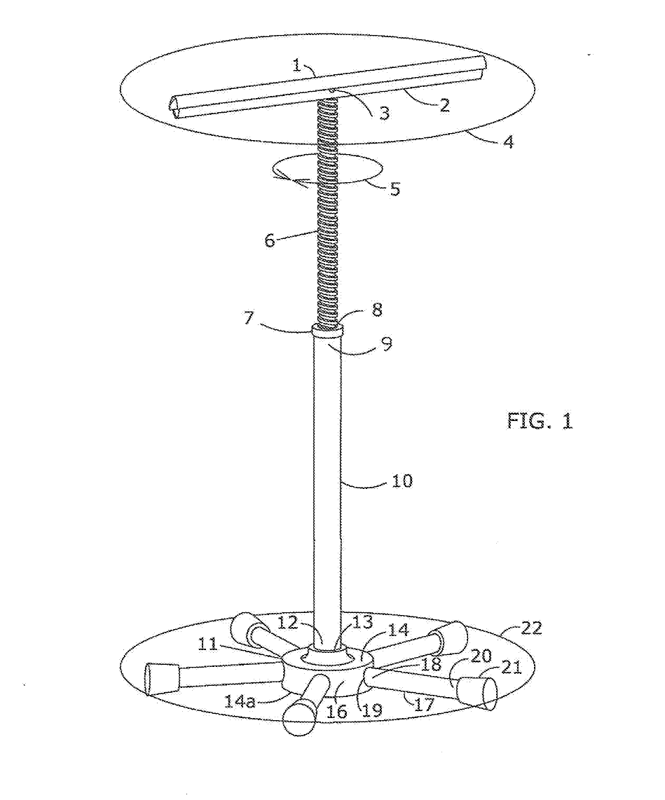

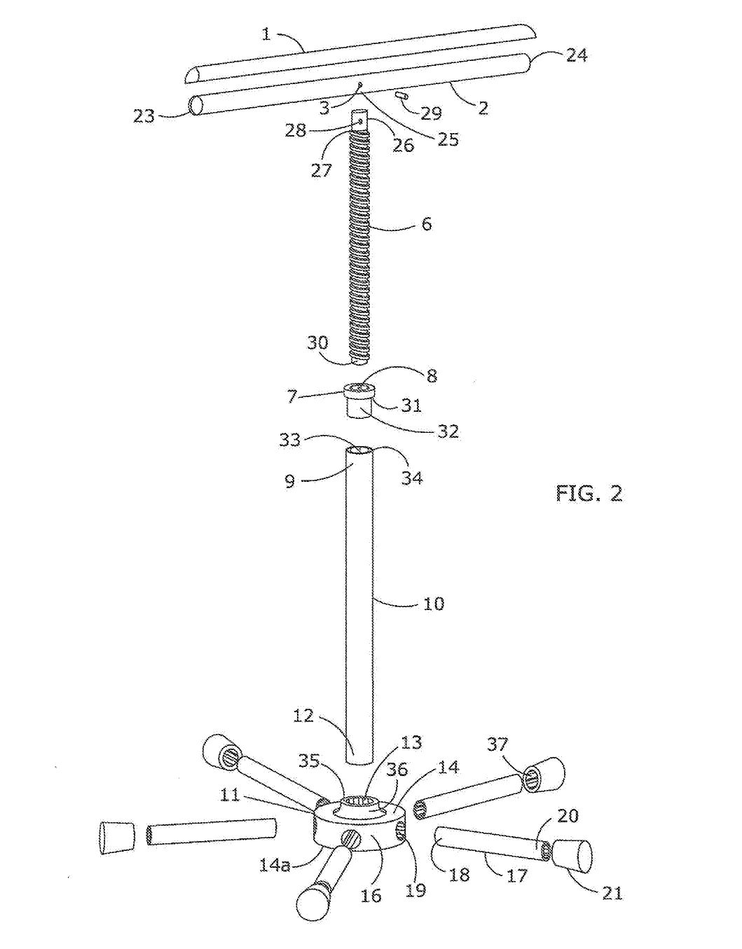

With reference now to the drawings, a novel and unique knee joint gravity assist passive flexion device embodying the principles and concepts of the present invention will be fully disclosed. Referencing now specifically FIG. 1 being a 3 dimensional illustration of the present invention; having a supple rubber pad 1 semi-encompassing the upper half of the horizontal knee posterior support bar 2 of equivalent length, it is considered non-essential having support bar 2 enclosed in full circumference; whereby having said rubber pad 1 feasibly detained, but not necessarily central, by some bonding means (e.g., glue, double-sided tape, stitching, Velcro, or some other commercially available attachment means). It will be apparent to those skilled in the art, said padding 1 could be in tube form; being single plane split lengthwise to mid-length and merely slid over said bar 2 length; further said padding 1 is solely intended for individual comfort; whereby the revealed present invention would be wholly functional if excluded. Continuing on with the externally threaded linear vertical traveling height adjustment rod 6, being of trapezoidal thread form; whereby such thread form, being industry recognized as Acme thread, utilizes broad flat externally exposed thread apex (or crest) surfaces, favorable towards exclusion of exposed thread edge sharpness; whereby offering accurate diminutive linear travel. Further having height adjustment rod 6 external thread engagement with cooperating internally threaded bushing 7 at thread engagement aperture 8; whereby having said threaded bushing 7 being affixed atop tube end 9 of vertical support housing 10. It will be apparent to those skilled in the art that it is here where the novelty and uniqueness of the present invention transpires; whereby having horizontal support bar 2 resolutely attached to said height adjustment rod 6 employing roll-pin 29, FIG. 2, introduced through aperture 3; thereby having adjustment rod 6 clockwise or counterclockwise rotation, represented by imaginary circular plane 5, being indistinguishable from horizontal support bar 2 clockwise or counterclockwise horizontal rotation, represented by imaginary circular plane 4. Further, whereby having desired height established of said support bar 2 preserved, while affording purposeful diminutive horizontal clockwise or counterclockwise rotational positioning movement liberty of said support bar 2. Whereby having impaired lower leg being extended out over the horizontal knee posterior support bar 2, whereas said support bar 2 now being considered a fulcrum; thereby fully supporting cantilevered lower leg, commencing at the posterior intersection relationship of the femur and tibia. Further conclusively divulging the present invention novelty and uniqueness by exposing the liberated rotating horizontal knee posterior support bar 2, whereas said support bar 2 having liberty towards anatomically self positioning; thereby accommodating for varying individual knee linearity geometry, while the extended lower leg gradually descends naturally while being gravity assisted; whereby providing proper horizontal and lateral support bar 2 positioning proportional to individual knee geometry during gravity assist passive flexion. Continuing on with opposing end 12 of vertical support housing 10 being press-fit inserted a determined depth in to accommodating nesting harbor bore 13; whereby said bore 13 being of center location atop horizontal plan 14 of center base hub 11, respectfully; whereby having numerous identical equivalent length appendages 17, extending horizontally outward from said center base hub 11 peripheral circumferential face 16; whereby having said appendage(s) 17 end(s) 18 press-fit inserted a determined depth in to accommodating geometrically equally spaced nesting harbor bore(s) 19; whereby said bores 19 being located on circumferential centerline of center base hub 11 circumferential face 16 between opposing parallel face lands 14 and 15, respectfully. Continuing with individual horizontal appendage(s) 17 being considered perpendicular relative to said vertical support housing 10; whereby said appendage(s) 17 opposing end(s) 20 having commercially available non-slip rubber cap(s) 21 snug slip-on fit attached; further having imaginary peripheral circular plane 22 representative of base support peripheral circumference being somewhat augmented from that of horizontal support bar 2 length rotation, represented by imaginary circular plane 4; therefore contributory towards realization of an uncompromising vertically stable support embodiment.

Referencing now FIG. 2 being an exploded 3 dimensional illustration encompassing essential components of the present invention; whereby having a supple rubber pad 1, FIG. 1; continuing on with horizontal knee posterior support bar 2, FIG. 1; whereby said support bar 2 having rounded ends 23 & 24; wherein said support bar 2 having a vertical coaxial bore location indicated by 25; whereby said bore 25 being located mid-span on longitudinal centerline of said support bar 2 lower half; additionally, said support bar 2 includes a mid-span, considered horizontal aperture 3, FIG. 1, wherein said horizontal support bar 2 having said aperture 3 being of longitudinal centerline location 90 degrees opposed of said vertical coaxial bore indicated by 25; having roll-pin 29, FIG. 2, indicated. Continuing now with external Acme threaded vertical linear traveling height adjustment rod 6, FIG. 1; whereby said adjustment rod 6 having one end 26 tolerance machined or formed a determined diameter; whereby said adjustment rod 6 having said machined end 26 exposed surface being of a desired length; whereby machined end 26 length termination being considered as a landing 27; whereby having said adjustment rod 6 machined end 26 include horizontal aperture 28; whereby opposing end 30 of beveled contour. Continuing on with said adjustment rod 6 cooperating internal Acme threaded bushing 7, FIG. 1: wherein said bushing 7 having a continual internal threaded aperture 8, FIG. 1; whereby having a horizontal landing 31 perpendicular to machined or formed circumferential face 32. Continuing now with vertical support housing 10, FIG. 1; whereby having opposed parallel blunt ends 9 & 12, FIG. 1, whereas said end 9 having a landing 34; whereby said support housing 10 being of tube form; wherein having a through bore 33. Further, center base hub 11, FIG. 1, being of determined diameter; whereby said hub 11 having a raised segment 36; whereby said segment 36 protruding vertically from said hub 11 horizontal surface plane 14, FIG. 1; whereas said elevated segment 36 having a plateau 35; whereby said plateau 35 and said horizontal surface 14 being parallel, respectfully. Continuing with said plateau 35 having a center located determined depth and diameter-nesting harbor bore 13, FIG. 1; whereby being accommodating towards press-fit insertion of said vertical support housing 10, end 12, FIG. 1. Continuing on with said circular center hub 11; wherein having numerous geometrically equally spaced nesting harbor bore(s) 19, FIG. 1, whereby said bore(s) 19 being located on the circumferential centerline considered between horizontal parallel planes 14, FIGS. 1, and 15, FIG. 1, respectfully, of said center hub 11. Continuing with the numerous equal length appendages 17, FIG. 1; whereby said appendage(s) 17 having end(s) 18, FIG. 1, will be press-fit in to accommodating bore(s) 19, FIG. 1, of said hub 11; whereby having appendage(s) 17 opposing end(s) 20, FIG. 1, accessible towards insertion in to commercially available rubber end cap(s) 21, FIG., 1, accommodating nesting harbor (s) 37.

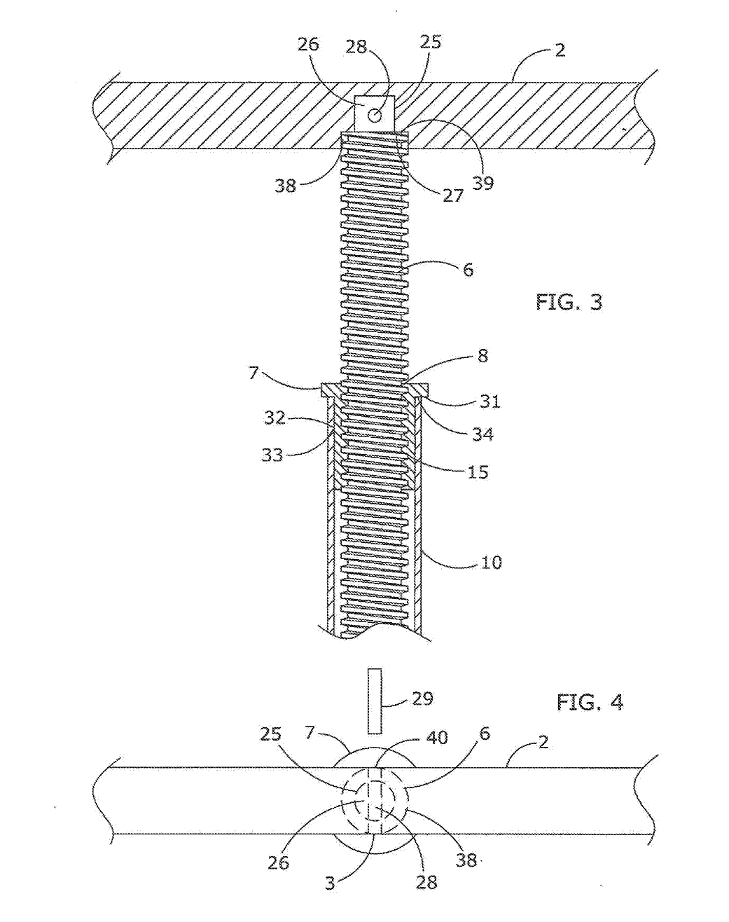

Continuing on with FIG. 3 being a forward facing partial sectional views of the knee posterior horizontal support bar attachment means illustrated in partial cross-section, and an illustration of the vertical height threaded rod adjustment engagement arrangement, again, in partial cross-section, of the revealed present invention preferred embodiment; whereby having knee posterior horizontal support bar 2, FIGS. 1 & 2, in cross-section, exposing determined depth coaxial bored hole 25, FIG. 2, and associated counter-bore 38; wherein having tolerance machined end 26, FIG. 2, of vertical linear traveling height adjustment rod 6, FIGS. 1 & 2, being fully nested in said bored hole 25. Continuing with having said height adjustment rod 6 landing 27, FIG. 2, interfacing with counter-bore 38 bottom surface land 39; sub-sequentially having a limited portion of exposed end threads of said height adjustment rod 6 nested in said counter-bore 38; whereby having preferred location of roll-pin accommodating aperture 28, FIG. 2, designated. Now continuing on with said external threaded height adjustment rod 6; whereby being thread inserted in to cooperating internally threaded bore 8, FIGS. 1 & 2, of bushing 7, FIGS. 1 & 2; whereby illustrating the combined threaded interface contact surface 29; whereby having said bushing 7 being press-fit in to accommodating tube bore 33, FIG. 2, of vertical support housing 10, FIGS. 1 & 2; whereby have said bushing 7 circumferential face 32, FIG. 2, fully interfaced with said housing 10 bore 33. Whereby said threaded bushing 7 land 31, FIG. 2, being fully interfaced with vertical housing 10 blunt end landing 34, FIG. 2.

Now precede on with FIG. 4 a partial downward view of the knee posterior horizontal support bar attachment means, illustration having hidden lines of the revealed present invention preferred embodiment. Whereby knee posterior horizontal support bar 2, FIG. 1, 2 &, 3, tolerance machined coaxial bore 25, FIGS. 2 & 3, being of resolute copulation with cooperating tolerance machined end 26, FIGS. 2 & 3, of externally threaded linear vertical traveling height adjustment rod 6, FIGS. 1, 2 & 3; whereby having said support bar 2 counter-bore 38, FIG. 3, illustrated. Continuing with having roll-pin 29, FIG. 2, so positioned towards insertion in to said support bar 2, FIGS. 1, 2 & 3, accommodating aperture 40 and opposed aperture 3, FIGS. 1, 2 & 3, whereby said opposing apertures 40 & 3 being so aligned with cooperating aperture 28, FIGS. 2 & 3, of said tolerance machined end 26 of said height adjustment rod 6. Whereby having internal Acme threaded bushing 7, FIGS. 1, 2 & 3, referenced for location purpose.

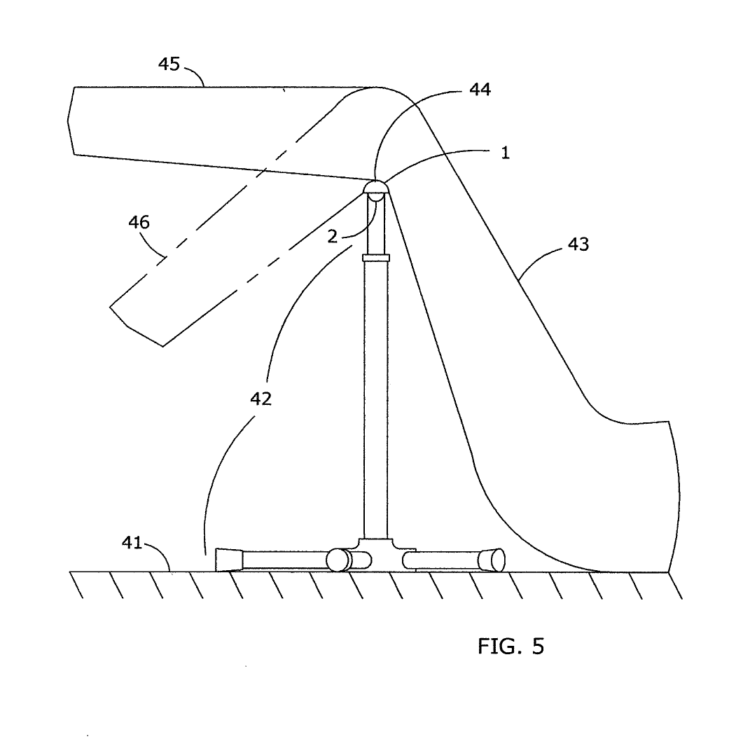

Move on to FIG. 5 being an artistic side view illustration of the revealed present invention preferred embodiment, in demonstration. Whereby having the present invention embodiment 42 placed preferably on a level surface 41; whereby having simulated upper leg 43 at a comfortable forward vertical angle; having the knee joint posterior 44 confidently positioned atop rubber pad 1, FIGS. 1 & 2, of horizontal knee posterior support bar 2, FIGS. 1, 2, 3 & 4; whereby simulated lower leg 45 being considered in cantilever; whereas having simulated lower leg 46 exemplifying descending gravity assist passive flexion. Further, it will be apparent to those skilled in the art that the revealed present invention preferred embodiment would be fully functional whereby having the subject in an alternative sitting position.

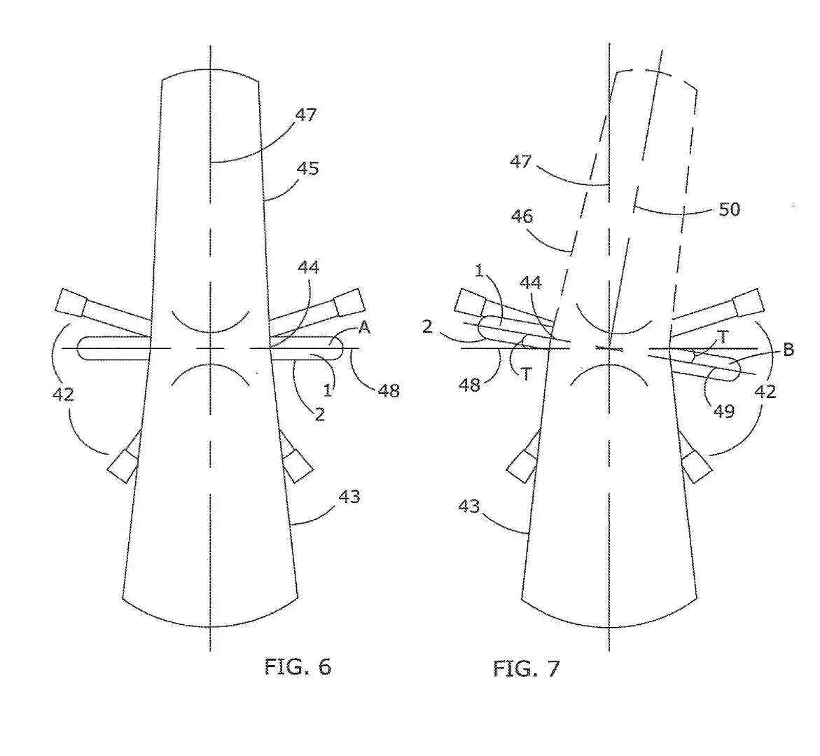

Continuing now with FIG. 6 being an artistic vertical downward view representative illustration of the revealed present invention horizontal knee posterior support bar preferred embodiment, in demonstration. Whereby having the present invention embodiment 42, FIG. 5, so center positioned under knee joint posterior 44, FIG. 5, whereupon resting atop rubber pad 1, FIGS. 1, 2 & 5, being affixed to horizontal knee posterior support bar 2, FIGS. 1, 2, 3 4 & 5; wherein having an imaginary longitudinal centerline 47 of simulated upper leg 43, FIG. 5 and simulated lower leg 45, FIG. 5, indicated. Now considering said lower leg 45 being in cantilever; having an imaginary lateral centerline 48 of said rubber pad 1 and said support bar 2 being indicated; whereby said centerlines 47 & 48 being considered perpendicular.

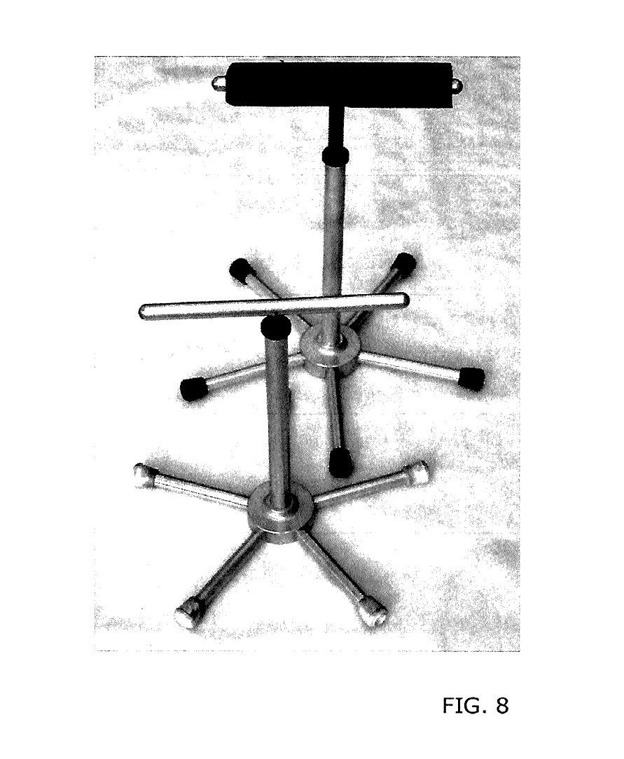

Concluding with FIG. 7 being an artistic vertical downward view illustration of the revealed present invention horizontal knee posterior support bar preferred embodiment demonstrating gyratory capability. Whereby having the present invention embodiment 42, FIGS. 5 & 6, so center positioned directly under knee joint posterior 44, FIGS. 5 & 6, whereupon having said knee posterior 44 resting atop horizontal knee posterior support bar 2, FIGS. 1, 2, 3, 4, 5 & 6 rubber pad 1, FIGS. 1, 2, 5 & 6, wherein having an imaginary longitudinal centerline 47, FIG. 6, of simulated upper leg 43, FIGS. 5 & 6, indicated. Now consider simulated lower leg 46, FIG. 5, descending; wherein having an imaginary longitudinal centerline 50 indicated, whereby imaginary lateral centerline 48, FIG. 6, and said longitudinal centerline 47, considered perpendicular; insomuch as with said support bar 2, having liberty towards anatomically self-positioning; thereby accommodating for varying individual knee linearity geometry, while said simulated lower leg 46, gradually descends, naturally, while being gravity assisted; thereby fully disclosing the unique gyratory self-positioning capability of said horizontal support bar 2, so exhibited considering said lateral centerline 47 to realized said support bar 2, lateral centerline 49 no longer considered perpendicular. It will be apparent to those of ordinary skill in the art that the illustrative representation of said support bar 2 lateral gyratory self-positioning being capable of opposed rotation.

Whereby having FIG. 8 being a photograph of the revealed present invention preferred embodiment exhibited with and without foam rubber padding.

With respect to the above description, it should realized that the optimum dimensional relationships for the parts of the invention, to include variations in size, materials, shape, form, function and manner of operation, assembly and use, are deemed readily apparent and obvious to those skilled in the art, and therefore, all relationships equivalent to those illustrated in the drawings and described in the specification are intended to be encompassed only by the scope of appended claims.

While the present invention has been shown in the drawings and fully described above with particularity and detail in connection with what is presently deemed to be the most practical and preferred embodiment(s) of the present invention, it will be apparent to those of ordinary skill in the art that many modifications therefore may be made without departing from the principles and concepts set forth herein. Hence, the proper scope of the present invention should be determined only by the broadest interpretation of the appended claims so as to encompass all such modifications and equivalents.

14. A device configured for knee muscle stretching comprising;
a horizontal support bar centrally attached atop a vertical bar having external threading thereon and having a first length,
a threaded bushing attached to a top of a tubular support housing,
said external threading on said vertical bar cooperating with said threaded bushing,
said tubular support housing having a bottom, said bottom of said tubular support housing being attached to a base support hub,
said base support hub including a plurality of stabilizing appendages extended horizontally outward from said base support hub, wherein said horizontal support bar may be moved vertically by rotating said vertical bar, causing said external threading to pass through said threaded bushing, moving said vertical bar downwardly into said tubular support housing when said vertical bar is rotated clockwise, and further moving said vertical bar upwardly when said vertical bar is rotated counter-clockwise, permitting said horizontal support bar to be supported at a specific distance above said threaded bushing.

15. A device configured for knee muscle stretching as claimed in claim 14 wherein said horizontal support bar permits the interface of the posterior knee portion of the leg of the user to rest thereon with the lower portion of the leg in a lowered position, and further permits the lower portion of the leg to be moved to a cantilevered position using gravity to resist such motion, and further permits the lower portion of the leg to be lowered using gravity to assist such motion back to the lowered position, such leg motion being made repetitively, thus stretching the knee muscles of the user.

16. A device configured for knee muscle stretching as claimed in claim 15 wherein said horizontal support bar is in a first position when the lower portion of the leg is resting on said horizontal support bar in a lowered position, and said horizontal support bar is in a second position when the lower portion of the leg is in a cantilevered position.

17. A device configured for knee muscle stretching as claimed in claim 16 wherein when said leg is moved from the lowered position to the cantilevered position, said horizontal support bar gyrates between said first position and said second position.

18. A device configured for knee muscle stretching as claimed in claim 17 wherein said horizontal support bar is covered with a material.

19. A device configured for knee muscle stretching as claimed in claim 18 wherein said horizontal support bar is cylindrical.

20. A device configured for knee muscle stretching as claimed in claim 19 wherein said material is further cylindrically shaped and further including a hollow center, said hollow center being so dimensioned as to cover said horizontal support bar, said material having a thickness at least that as the diameter of said horizontal support bar.

21. A device configured for knee muscle stretching as claimed in claim 20 where said material is comprised of foam rubber.

22. A device configured for knee muscle stretching as claimed in claim 17 wherein said first position and said second position of said horizontal bar is separated by an angle.
